(19) United States
(12) Patent Application Publication
(10) Pub. No.: US 2016/0314274 A1
(43) Pub. Date: Oct. 27, 2016

(54) PRESCRIPTION SECURITY SYSTEM

(71) Applicant: Harald Zieger, Milford, OH (US)

(72) Inventor: Harald Zieger, Milford, OH (US)

(21) Appl. No.: 15/136,174

(22) Filed: Apr. 22, 2016

Related U.S. Application Data
(60) Provisional application No. 62/152,310, filed on Apr. 24, 2015.

(51) Int. Cl. G06F 19/00; G06F 21/31

(52) U.S. Cl. CPC G06F 19/3456; G06F 19/328; G06F 21/31

(57) ABSTRACT

Provided is a Prescription Security System which secures the appropriate selection, examination, administration and consumption of prescription drugs. The Prescription Security System eliminates many weak points in the prescription chain from the physician through the pharmacy and patient by combining specific hardware and software with existing data structures in such a way that errors and mistakes are reduced dramatically. In addition to the increased security in the prescription process, any misuse, whether deliberate or unintentional, is essentially eliminated. This leads to an enormous reduction in malpractice claims, reduces the amount of money insurers have to put into liability reserves, and can significantly reduce the insurance rates for practitioners, and with that the total cost of health care. It is also a potential cost reduction system for government controlled health care programs such as Medicaid, Medicare, and the Veterans Administration (VA).

### I. BACKGROUND

1. Technical Field

This application relates to an electronic system having an integrated system of specific hardware and software, encompassing a microcomputer controlled drug case and connection base, inseparably connected with a proprietary software package to regulate and control the functionality of the drug case and connection base. Also included is a computer software package consisting of three parts, the MDP (Medical Doctor Package), PHP (Pharmacy Package), and the PAP (Patient Package).

2. Background

Accidental death from prescription drugs, even when they are correctly given, is now the fourth leading cause of death in the U.S. In 2007, there were 27,658 unintentional drug overdose deaths in the United States. The number involving opioid analgesics was 1.93 times the number involving cocaine, and 5.38 times the number involving heroin. Overdose deaths have now overtaken the annual number of automotive crash fatalities in 16 states, and are more than double the annual number of murders nationwide. Clearly, there is a widespread problem.

Community pharmacists dispense three (3) billion prescriptions annually. Fifty (50) million incorrect prescriptions are delivered to patients each year. Three (3) million of the fifty (50) million mistakes could have caused harm. Americans spend $220 billion per year to purchase three (3) billion prescriptions. An additional $177 billion is spent to correct drug therapy related problems. More prescribing errors occur between 12 noon and 3:00 PM than any other time. According to the American Society of Health-System Pharmacists (ASHP), one patient per hospital each day will experience a medication error. Missing doses is by far the most common medication error.

One and one-half (1.5) million patients are injured each year due to medication errors, costing hospitals $3.5 billion. Seven hundred thousand (700,000) patients are sent to the emergency ER each year because of harmful reactions to commonly used drugs. The National Patient Safety Foundation found that 1 in 3 Americans have been affected by serious medical mistakes.

At about $330 to about $1130 billion yearly, adverse drug reactions (ADR) create greater total costs for morbidity and mortality than that of cardiovascular disease or diabetic care. ADRs cause 1 out of 5 injuries or deaths per year to hospitalized patients. Mean length of stay, cost, and mortality for ADR patients are double than that of control patients. Another study, in 2008, by the Office of Inspector General for the Department of Health and Human Services, reported grave evidence that something is amiss in the hospital setting in America. The study found that physician reviewers determined that 44 percent of the adverse and temporary harm events “were clearly or likely preventable.” The cost of these mistakes was estimated at $324 million in October alone. The mistakes equate to 3.5 percent of the Medicare budget.

A 1990 article estimated that a pharmacist who is 99% accurate over 40 years of practice, in which 480,000 prescriptions are dispensed, will likely cause the death of 6 patients. One research study suggested that errors occurred more frequently at the beginning of each month.

The number of deaths reported from the use of over-the-counter OTC and prescription drugs increased from 34,966 (1998) to 89,842 (2005).

A study by the non-profit group U.S. Pharmacopeia determined that morphine-based medications are among the most common errors that lead to death or injury. The cost of medication-related malpractice claims: From 1977-1988, one carrier paid $30 million for medication-related claims. From 1988-1997, another carrier paid $29 million for medication-related claims.

Even though the government has recently installed regulations leading to the digitization of all medical files and drug prescription through computer aided systems, the main part of the mistakes—the chain between prescription, fulfillment, and consumption—of prescription drugs is as fragile as ever. The problem could even get worse since too many people rely on computer systems and programs for which they have no training and have become more complex than ever.

Moreover, approximately 77% of all errors in prescription related malpractice claims are caused by two reasons: errors in ordering and errors in administration. If these errors could be eliminated or at least dramatically reduced, the number of malpractice claims the insurance industry receives would plummet which would in turn, reduce the requirement for extremely expensive insurance premiums. More importantly, eliminating these errors would save countless lives and improve the health and quality of life for a multitude of individuals. The present disclosure provides a solution to these problems associated with issuing, filling and administering prescriptions.

### II. SUMMARY

Provided is a prescription security system. The prescription security system includes an electronically controlled drug container which includes a memory, a microprocessor, a software package, a power source, an input port and an output port. The drug container receives and transmits data related to a patient through the input and output port.

Also included within the prescription security system is a physician software package. The physician software package includes a protocol for writing a prescription for the patient and allows prescription data to be entered into the drug container upon completion of the protocol. The drug container software package communicates with the physician software package to load prescription data into the memory of the drug container.

Also included within the prescription security system is a pharmacy software package which provides a protocol verifying and authenticating the prescription data stored on the drug container and a protocol for verifying the identity of the patient. The drug container software package acts as an interface between the drug container and the pharmacy software package.

### III. DEFINITIONS

Drug Container (DC)—Prescription drug container.

Connection Base (CB)—secure and locked basis station to identify, program, fill, and authorize the DC.

Medical Doctor Package (MDP)—software package to be used at the doctor's office.

Pharmacy Package (PHP)—software package to be used at the pharmacy.

Patient Package (PTP)—software package for the patient.

### IV. BRIEF DESCRIPTION OF THE DRAWINGS

At least one embodiment of the present teachings is set forth in the following description and is shown in the drawings and is particularly and distinctly pointed out and set forth in the appended claims.

FIG. 1 is a perspective view of an exemplary closed drug container.

FIG. 2 is a perspective view of an exemplary open drug container.

FIG. 3 is a perspective view of an exemplary connection base.

FIG. 4a is an exploded perspective view of an exemplary drug container.

FIG. 4b is an assembled perspective view of an exemplary drug container.

FIG. 5a is a perspective view of an exemplary compartment lid for a drug container.

FIG. 5b is a side view of an exemplary compartment lid for a drug container.

FIG. 5c is a top view of an exemplary compartment lid for a drug container.

FIG. 5d is a rear view of an exemplary compartment lid for a drug container.

FIG. 5e is a bottom view of an exemplary compartment lid for a drug container.

FIG. 6a is a perspective view of an exemplary locking assembly for a drug container.

FIG. 6b is an exploded perspective view of the locking assembly.

FIG. 6c is an exploded front view of the locking assembly.

FIG. 6d is a front view of the locking assembly.

FIG. 6e is a top view of the locking assembly.

FIG. 6f is a side view of the locking assembly.

FIG. 7a is a perspective view of an exemplary connection base for a drug container.

FIG. 7b is a top view of an exemplary connection base for a drug container.

FIG. 7c is a bottom perspective view of an exemplary connection base for a drug container.

FIG. 7d is a front view of an exemplary connection base for a drug container.

FIG. 7e is a side view of an exemplary connection base for a drug container.

FIG. 7f is a side view of an exemplary connection base for a drug container.

FIG. 7g is a bottom view of an exemplary connection base for a drug container.

### V. DETAILED DESCRIPTION

The present disclosure provides an electronic system which may be used to eliminate the potential source of mistakes in prescribing necessary drugs at the doctor's office. In addition to numerous features described herein the electronic system may be used to eliminate mistakes by:
a) Double checking a patient's drug history against the database of the doctor's office;
b) Double checking potential interference and counter indications with other prescribed drugs against national and international drug databases; and,
c) Explicitly connecting a Drug-Container (DC) based on identification information of the patient (e.g., a patient's Social Security Number (SSN) and biometric identification).

The functionality of the electronic system rests with its software and a drug container. At the physician's office, the software may include a combination of a physician software package and a drug container software package. By this means, the drug container is programmed and can only be removed from a connecting port at the physician's office when the computer software has determined that there are no known counter-indications and no interference with existing prescriptions.

At the pharmacy, the drug container may be placed on another connecting port and may be unlocked by the patient with a code. Once unlocked, the pharmacist can fulfill the prescription by uploading securely stored prescription information from the drug container into a pharmacist software package. The pharmacist software package has all the security measurements according to state and federal regulations and does additional data checks for counter-indications and known adverse reactions utilizing national and international databases as far as available and accessible. If the prescription is for more than 7 days, there will be an opportunity to refill the drug container by transfer of authorization from the original patient to a person of his/her trust. This will implement several additional security steps of identification to ensure that misuse is limited to almost zero. This transfer of authorization can also take place in case of drugs prescribed to underage persons and in case parents have to change certain oversight measures with respect to the consumption of prescription medications by their children. The patient may have access to software which contains all the features necessary to have a comfortable setup to consume the prescription drugs as prescribed, at the right time, and in the right dosage. The software may issue reminders of when to take certain medication, alerts to avoid missed dosages and when it's necessary to refill the prescription. The software may provide the patient with any information related to the patient's prescription or health and may include various control features. The software may be run on all modern communication systems and devices including both mobile and stationary devices.

The electronic system has several benefits over traditional handling of prescription drugs. Mistakes and errors by stressed out and overloaded physicians as well as pharmacists are reduced dramatically, if not eliminated altogether. Mistakes and errors on the patient's side as well as misuse of prescription drugs by unauthorized individuals are eliminated. This includes the elimination of accidentally or unauthorized consumption of prescription drugs by minors of parents' and/or grandparents' prescription drugs which has risen to alarming proportions.

Further features of the present disclosure will become apparent from a consideration of the ensuing description and accompanying drawings.

In the present disclosure envisioned above, the electronic system includes a software package and a device. In certain embodiments, the software is separated into three parts. The three software parts include software for the doctor's office, software for the pharmacist, and software for the electronic controlled medication device. However, in certain embodiments, the software package may include any one of these parts absent any of the other software parts as the electronic system may be operated with at least one software part. Furthermore, the software package may include any number of parts in addition to the software for the doctor, software for the pharmacist and software for the electronic controlled device as may be deemed useful to facilitate the operation of the electronic system. In certain embodiments, the electronic system may be described as a prescription security system (PSS).

Physician Software Package (MDP)

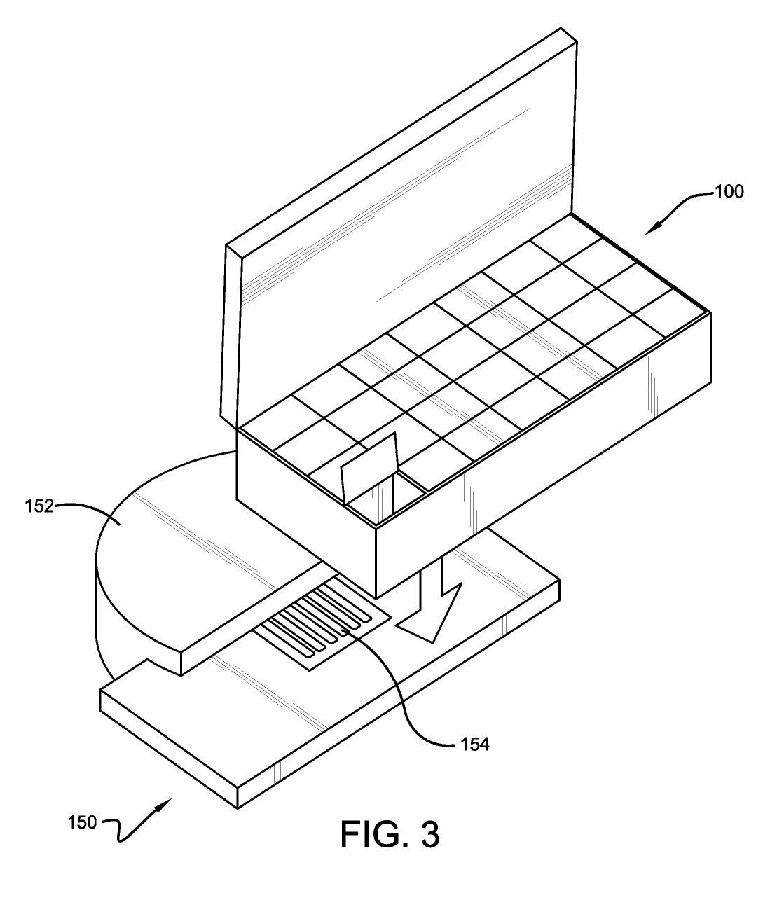

The doctor's package (also referred to herein as the “physician software package”, “medical doctor package” or “MDP”) works to ensure that the right prescription drug is prescribed to the right person. This is based on several security elements included in the software. For example, whenever the doctor or physician wants to prescribe a drug to a patient, using the already installed physician software package on his or her computer system, the Prescription Security System (PSS) would require a double check of certain identification information of the patient. Such identification information may include the social security number (SSN) of the patient. In certain embodiments, the identification information may include a biometric identification of a patient. In certain embodiments, the biometric identification may constitute the sole identification information that is to be checked while in other embodiments, it may constitute a secondary identification input which is used in conjunction with a primary identification input. In certain embodiments, the biometric identification input may be a finger print reader. However, any type of biometric identification input suitable for use in the art may be used. In further embodiments, the PSS may require the input of a patient and/or physician password alternatively or in addition to the patient's identification information. The PSS may also require the placement of a drug container (DC) on a physician connection base (CB). Without the input of the required patient identification information and/or placement of the DC on the physician CB, the PSS may be programmed to block the software from issuing a prescription. An example of a drug container (100) being placed on a connection base (120) is illustrated within FIG. 3. As shown within FIG. 3, the connection base (150) includes a dock (152) and data connectors (154) which electronically connect the connection base (150) to a port on the drug container (100) and allow the drug container to electronically communicate with the physician's computing device which is running the physician software package. When the identity of the patient is determined, and the drug container is placed on the connection base (FIG. 3), the doctor can begin to fill the prescription for this specific person. The following will serve as an illustration of the procedure.

Patient A needs a specific drug B, which the doctor has reviewed in the usual catalogs (i.e. Micromedex, Wolter Kluwer as well as any other software based medication catalogs). After reviewing and/or considering a specific drug, the doctor decides to prescribe drug B. At the same moment, the PSS checks the prescription history of patient A to compare all of the other, already prescribed drugs for interactions with drug B. If the PSS finds that there are interactions with those drugs, it will list all of them on the screen of the doctor's computing device and mark them in different colors based on the severity of the potential interaction. If there is a possible dangerous interaction, the PSS will create a specific warning for the doctor. If the doctor decides that a generic drug can serve as an alternative, he has to list it in the prescription and the same safety procedure would be applied to the generic drug as well.

When the check is finished, the doctor enters the dose, how many doses per day, the interval, and a maximum dosage within the physician software package. The PSS would then run a check of all of this data against the regulations and catalogues containing patient A's personal data (i.e. age, weight, etc.). After this check is complete, the prescription is ready to be loaded onto the drug container (DC). The download onto the DC always includes a verification which matches the DC to patient A. For security reasons, all the information downloaded onto the DC is encrypted and is only accessible with the correct software and at least the patient's identification information or password, for example, the patient's SSN. In certain embodiments, the encryption process is an automated encryption process and begins as soon as the physician closes the prescription for the patient. An encryption key is created by implementing the digitalized data of the fingerprint reader, the patient identification information (e.g., the patient's SSN or biometric information) and the license identification of the physician. The encryption may be at least 256 Advanced Encryption Standard (AES) or higher. In certain cases, the type of encryption utilized is based on the microcomputer power available and the cost of the DC. Once the encrypted file is created, it is sent to the chosen pharmacy through an Electronic Data Interchange (EDI).

If the prescription is an ongoing prescription for long-term care, the doctor can load the data for that prescription to additional DCs, which would be locked at the pharmacy. The additional DCs would be locked in a way that ensures they can only be used by the patient when use of the prior medication within a previously filled DC has been verified to have been completed. Additional DCs may be locked against each other according to the numbered dosage and the dosage per DC to ensure that only one (1) DC can be accessed at a time. In a further embodiment, at least one additional DC may be filled with a prescription different from that filled within a first or previously filled DC. In such embodiments, the additional DCs may be locked against each other according to the numbered dosage and the dosage per DC to ensure that only (1) DC can be accessed at a time and that a second or additional DC may only be opened by the patient after the prescription within a first or previously filled DC is first taken by the patient.

Pharmacist Software Package (PHP)

After the prescription is entered onto the DC according to the procedure set forth above, Patient A hands the prescription-filled DC to the pharmacist who connects the DC on a pharmacist connection base (CB) to electronically connect the DC to the PHP run on the pharmacist's computing device. In certain embodiments, once the DC is connected to the CB, a fingerprint reader on the DC may require a patient's input to verify the identity of the patient. This fingerprint reader may located anywhere on the DC, however, in certain embodiments, it is located on the outside portion or the inside portion of the lid of the DC.

Once the patient's identity has been verified, the connected computer with the pharmacy package searches and identifies the encrypted prescription file sent from the physician's office by means of the patient identification-based encryption keys (e.g., the fingerprint reader and the SSN-based encryption keys). When the prescription has been identified as the correct one for patient A, the encrypted description will be downloaded into the DC through the CB. This can only be accomplished if the identification procedure between the previously entered into the DC (e.g., the identification entered for the fingerprint reading and the SSN type-in into the DC) was positively identified as the encrypted keys that triggered the prescription identification on the pharmacy computer. With the connected DC identified and locked to the specific patient and the specific prescription, the prescription may be decrypted and loaded into the software screen on the pharmacy computing device monitor. At this point, the lid on the DC may be unlocked and since the DC is not programmed with the prescription data yet, all of the compartment lids will open at the same time.

The connected computer with the pharmacy package, now loads the data from the DC and automatically checks the authenticity of the prescription against the doctor's records, the patient, and the prescribed drug database. In order to fill the prescription, a first and second identifier of the patient are entered (i.e. SSN, driver's license number, etc.) into the pharmacy software package. The pharmacist opens the prescription on his software package and the PSS automatically begins a verification check. In the same way as the verification happened at the doctor's office, it is now verified with the database of the pharmaceutical industry for pharmacies. The pharmacist cannot alter the prescription. In certain embodiments, only where the doctor listed an alternative generic drug, can the pharmacist decide to fill the DC with the generic drug while in other embodiments, the pharmacist may have authority to fill the prescription with a generic drug if available.

Based on the prescription and the software arrangements operating the DC, the pharmacist will fill the DC chambers with the drugs as prescribed, according to dosage, interval, and number of doses (see details at the Electronic Controlled Device Drug Container (DC) description). In certain embodiments, the DC contains multiple compartments having a size of 1″×1″×1″ (inches) per compartment, although the compartment size may vary according to the intended use and specific needs of the patient. Such compartment sizes may constitute a sufficient size for the amount of pills/capsules necessary to fill a prescription and to add several additional medications per service if necessary. In the event that the compartment size is insufficient for one serving, the pharmacist may extend the filling of additional compartments and lock those compartments together. In the case where the prescribed drug(s) are to be taken for a long term treatment, the pharmacist may connect two or more DCs to the patient and the specific prescription in the same way as described before with the first DC. This includes typing the data of the prescribed drug into the specific fields on the computing device screen and waiting for confirmation of the correct application. For example, there may be up to four DCs prescribed by the doctor. In such cases, the pharmacist will fill all of the DCs and the pharmacy software would lock the DCs according to the prescribed usage.

Device Package (PTP or DC Package)

The DC software package (also referred to herein as the “patient software package”, “PTP”, “DC software package” or “DC package”) is the basic interface for loading the prescription into the memory of the DC. It also allows the DC to secure the data within its memory, makes the data available to the pharmacist, and controls the usage of the prescribed drug as intended by the doctor. The DC software package also processes an electronic comparison between the transmitted prescription file via an Electronic Data Interchange (EDI) to ensure that the transmission has not been corrupted. It also allows the pharmacist to obtain access to the data in case of a loss of data at the pharmacy computer. After the download of the data from the physician's computer, the data is stored in a temporary and encrypted file within the DC. With the confirmation of the prescription by the pharmacist, the DC package unlocks the lid of the DC, determines the number of chambers needed per day, arranges the chambers of the DC in a way that the numbers of doses per day are best situated, loads a graphic of the chamber at the screen on the lid, shows the drug name and the number of pills for each chamber, and has each chamber according to the number of doses and days served with a backlight (e.g., a green backlight), with all others having a backlight of a different color (e.g., a red backlight). The same graphic will be shown on the pharmacist's computer screen, including additional information identifying the drug to be filled for each of the chambers. When a chamber is filled correctly, the chamber on the computer screen can be set to “OK” or other positive verification by the pharmacist. When all green lit chambers are filled, the pharmacist can close the lid of the DC, which then locks. It is understood that the backlights denoting filled and empty chambers may be identified with lights of any color and that such backlights are not limited to only green and red. In certain embodiments, the patient may unlock the DC lid with an additional device. The additional device may be a wristband; a card using Near Field Communication (NFC) or Radio Frequency Identification (RFID) technology (or any other device capable of electronically or remotely sending a signal); or a key or key-like device (e.g., a key fob which uses infrared, challenge-response authentication or radio frequencies to open the DC). This additional device is programmed at the same time the DC is loaded with patient A's dataset. In a further embodiment, a biometric identification system may be integrated within DC. The biometric identification system may allow for the lid of the DC to be locked and/or unlocked through a patient's unique biometric input. The biometric input may be received through a scanner which is integrated within the DC. Examples of biometric information which may used to control access to the DC include but are not limited to a patient's fingerprint scan, retinal scan, facial recognition scan or a combination of various biometric scans. The biometric input may be used in addition to or as an alternative means for locking and unlocking the lid of the DC.

The DC package may further include the ability to connect to a separate programmable device. Examples of a separate programmable device which the DC package may be connected to include but are not limited to a home computer, a television, a smart watch, etc. The connections may be established via a wired or wireless connection such as WiFi to send alert information about an upcoming dose, alarms which indicate that a period of time has expired for a service, that it is time to consume or administer a dosage, that it is time to schedule an appointment with a physician and to provide other information about the drug (such as interactions with other drugs, as well as specific warnings about consumption with alcohol or operating a vehicle). The DC package may be programmed to separate applications which are run on the programmable device. These applications may be downloadable at the discretion of the patient and will allow no data about the prescription drugs or any kind of related data to be transferred through insecure Wi-Fi connections. It should be understood that although the basic procedure and protocol for the electronic or prescription security system has been described above, many more functionalities are possible.

Once the pharmacist confirms the identified prescription with the PHP, the DC software package performs the following functions:
1. It unlocks the lid of the DC;
2. It determines the number of chambers needed per day;
3. It arranges the chambers of the DC in a way that the numbers of servings per day are best situated;
4. It loads a graphic of the chamber or chambers on the screen on the inside or outside of the lid;
5. It shows the drug name and the number of pills for each chamber; and
6. It identifies each filled chamber according to the number of servings and days served with a backlight of a first color (e.g., a green backlight) and all unfilled chambers with a backlight of a second color (e.g., a red backlight).

When the appropriate compartment is filled, the pharmacist pushes down the compartment lid and it locks automatically. The pharmacist goes on with this procedure until the prescription is filled. In the event that there are several DC are to be filled, the DCs can only be filled one by one and the preceding DC must be closed before the next one can be filled. In certain embodiments, all DCs are locked against each other and the second or subsequent DC can only be opened when the previously opened or used DC is empty.

Electronic Controlled Device (DC)

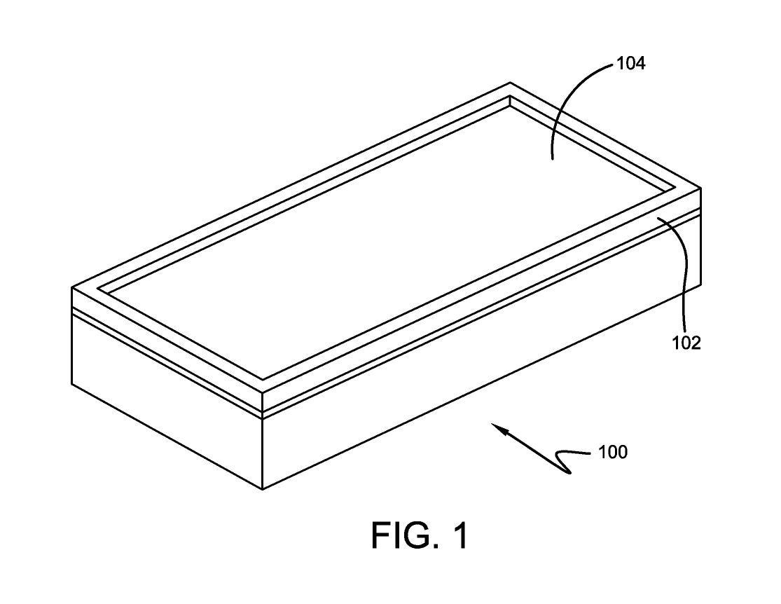

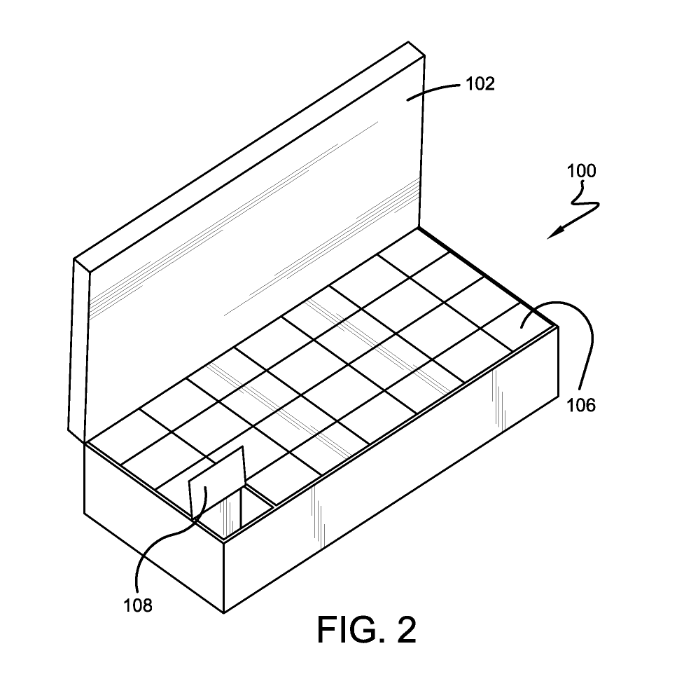

The drug container (DC) may be fabricated from any suitable material such as a metal or a plastic material. In certain embodiments, the drug container is a plastic container with dimensions approximately 7″×4″×1.5″ (inches). In further embodiments, the drug container may have 28 chambers to indicate 4 doses per day for 7 days. The size of each chamber may be 1″×1″×1″ (inches). It is to be understood that the number of chambers and the dimensions listed are simply aspects, and not to be construed as specific limitations. It is also to be understood that the DC could be made of any material desired that would enable an easy to use, secure container. The electronic system could be secured against manipulation such that all data is erased at the moment of unauthorized opening. The electronic system may be placed anywhere within the DC. In certain embodiments, the electronic system may be placed partly within a subfloor-like attachment. In one aspect, the DC is made from partly translucent material, and LEDs, for signaling certain situations, would be placed on the DC. Other electronics could be placed on the lid, such as a LCD/LED screen to act as a user interface allowing communications with the DC software package or PTP. The DC may also include a battery. In certain embodiments, the battery is rechargeable and may have a capacity of approximately 7 days without charging in sleep mode and 24 hours in operational mode although the battery is not intended to be limited to these specific charge capacities and may have any charge capacity which would allow for the operation of the DC. An example of a DC is illustrated within FIGS. 1 and 2. FIG. 1 illustrates an exemplary drug container (100) and lid (102) in a closed configuration. The DC of FIG. 1 includes a touch screen user interface (104). FIG. 2 illustrates an exemplary drug container (100) in an open configuration. The DC of FIG. 2 includes twenty-eight chambers (106) into which various drugs can be inserted. FIG. 2 illustrates a further embodiment wherein each chamber (106) includes an additional lid (108) to allow access to specific drug(s) within the chamber (106). As is the case with the primary lid (102), the chamber lids (108) may be controlled electronically through the DC software package to only allow access to specific drugs at certain times when those drugs are to be administered. If the patient misses a specific time frame for taking a specific drug, the chamber lid (108) may be permanently locked to prevent the patient from gaining access to drugs within multiple chambers. This feature may be used to prevent a patient from overdosing on certain drugs and can allow the physician and/or pharmacist to track drug usage. Any locked chamber lids (108) may be opened by the physician or pharmacist using the physician software package or the pharmacist software package.

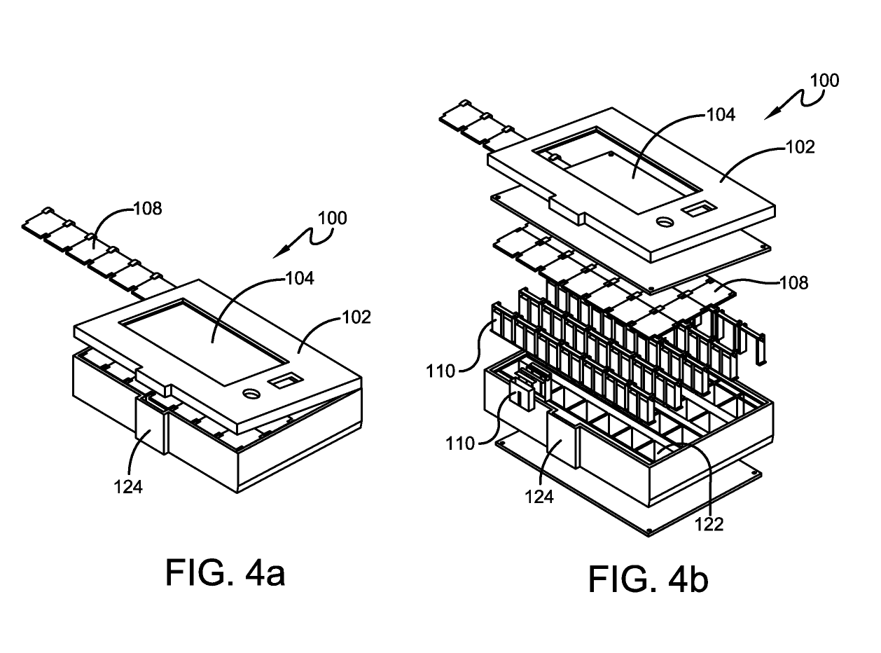

FIGS. 4a through 7g illustrate an exemplary embodiment of the drug container (100).

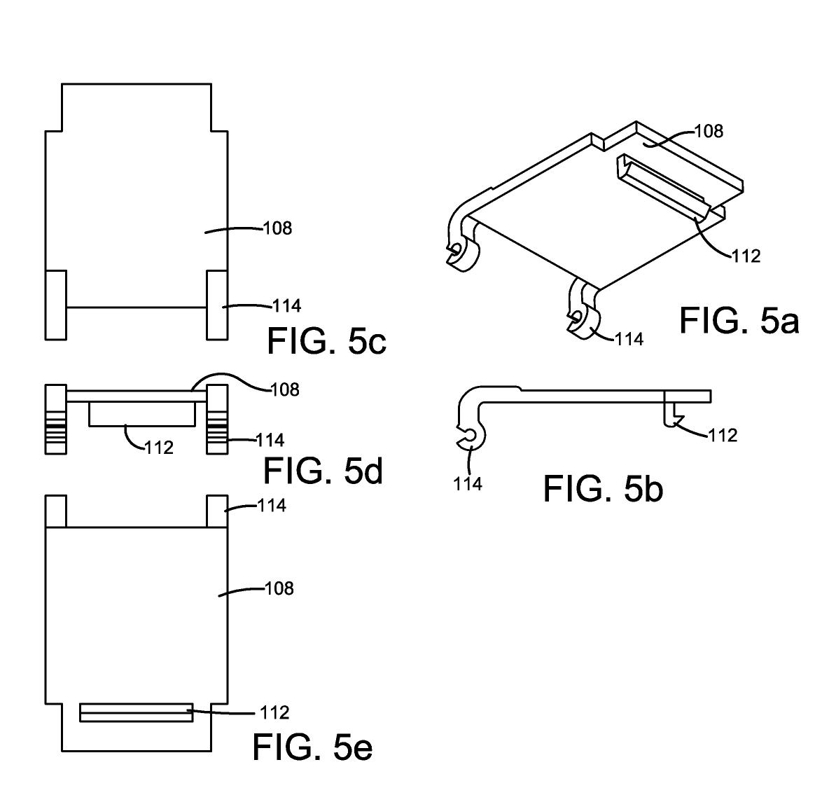

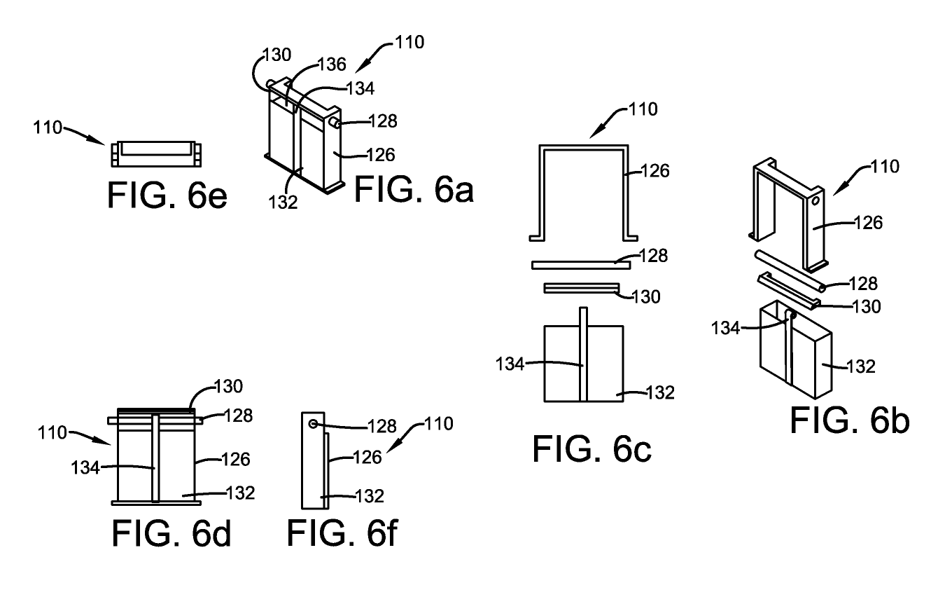

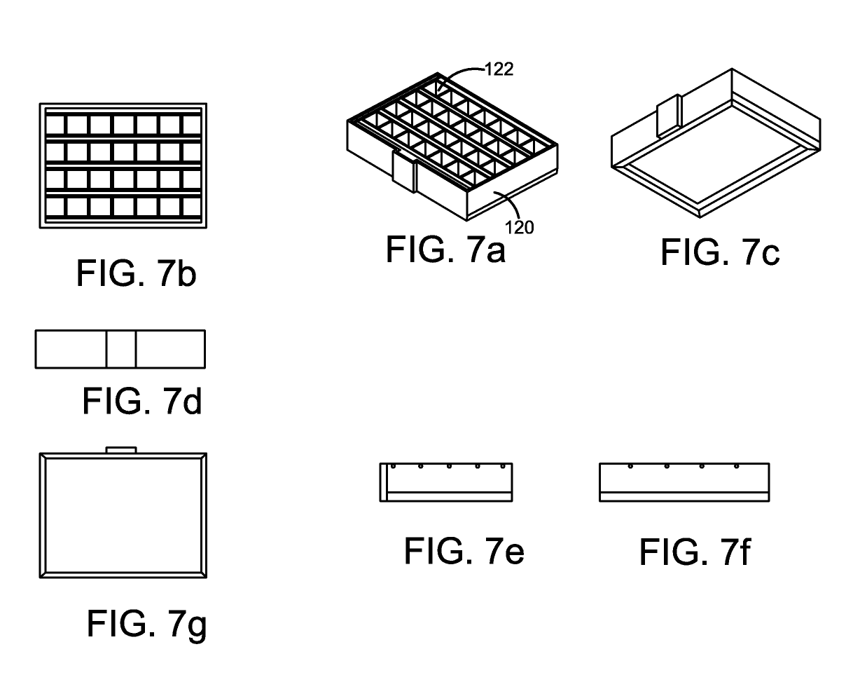

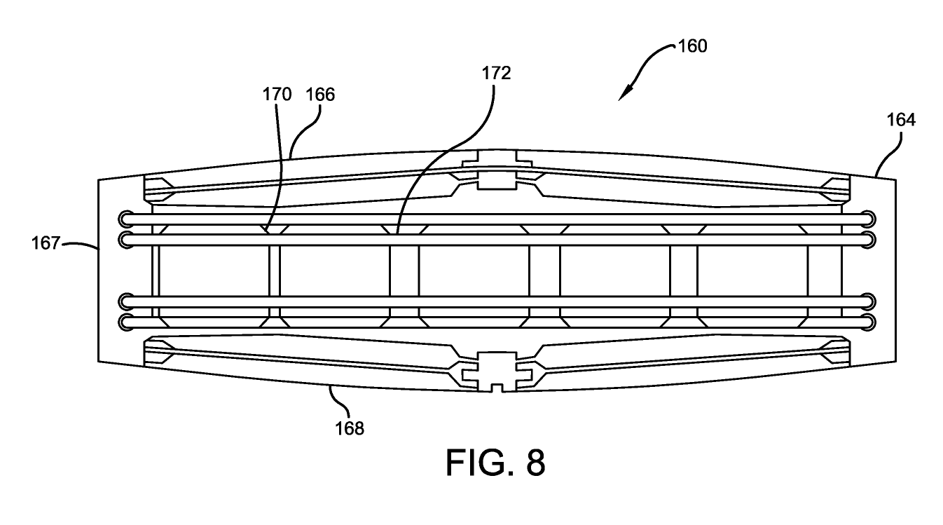

FIG. 4a illustrates a drug container (100) which includes a touch screen user interface (104) accessible through an opening within a primary lid (102) of the drug container (100). The drug container (100) includes a base (120) and various compartments or chambers (122) as illustrated within FIGS. 7a through 7g. Positioned over each chamber (122) is a chamber lid (108) as illustrated within FIGS. 5a through 5e. Each chamber (122) includes a locking assembly (110) as illustrated within FIGS. 6a through 6f. The locking assembly (110) is positioned within the chamber (122) and is used to lock the chamber lid (108) over the chamber (122) to close access to the chamber (122). In addition, a locking assembly (110) is also provided to lock the primary lid (102) to the base (120) of the drug container (100) as illustrated within FIGS. 4a and 4b. This locking assembly (110) may be positioned within a pocket (124) within a side portion of the base (120).

More particularly, the chamber lid (108) may include at least one hook portion (114) on its back side which connects to a rod (not shown) positioned along the back side of the chamber (122) to form a hinge. This hinge allows for the opening and closing of the chamber lid (108) with respect to the chamber (122). The chamber lid (108) also includes a latch (112) which is positioned towards the front side on the bottom of the chamber lid (108). Exemplary embodiments of these features are illustrated within FIGS. 5a through 5e. As mentioned above, the chamber lid may be locked in place by establishing a connection between the chamber lid (108) and a locking assembly (110). In this regard, a locking assembly (110) is positioned within each chamber (122) and includes a bracket (126), a pin (128) which allows the bracket to be rotatable with respect to a locking assembly base (132), a connecting rod (134) which connects the base (132) to the pin (128) thereby connecting the base (132) to the bracket (126) and a base support piece (130) which further connects the base (132) to the pin (128) thereby connecting the base (132) to the bracket (126). To lock the chamber lid (108) to the locking assembly (110), the front end of the chamber lid (108) is rotated downwards towards the locking assembly until the latch (112) engages the pin (128) as the latch (112) fits within an opening (136) formed between the base (132) and bracket (126). In order to unlock the chamber lid (108), the base support piece (130) is disconnected from the pin (130). This allows the bracket (126) to rotate about the pin (128) to disconnect the connecting portion of the bracket (126) from the latch (112). In certain embodiments, the top end of the bracket (126) may rotate in a forward direction about the pin (128) to disengage the bracket (126) from the latch (112). Exemplary embodiments of these features are illustrated within FIGS. 6a through 6f. As mentioned above, operation of the latching mechanism may be accomplished electronically as the DC receives instructions from the patient through the device software package, the physician through the physician software package (MDP) or through the pharmacist through the pharmacist software package (PHP). Also, the component parts of the latching mechanism may be fabricated from metal and/or plastic materials.

In certain embodiments the DC (100) may also include an electronically controlled micro-actuator which fits within the chambers (122) of the DC (100). The micro-actuator may be positioned anywhere within the chamber (122) of the DC (100) which would allow for operation of the latching mechanism, however, in certain embodiments, the micro-actuator is positioned along the back portion of the chamber (122) and is connected to the bracket (126). As shown within FIG. 8, an exemplary micro-actuator (160) may include a first end (162), a second end (164) a first flexible lateral side (166) and a second flexible lateral side (168). In certain embodiments, the natural state of the micro-actuator (160) (in particular, the first and second flexible sides (166) and (168)) is in an expanded condition. This allows the micro-actuator (160) to exert a pressure on either the chamber lid (108) or the locking assembly (110) to enable chamber lid to remain in a closed position with respect to the chamber (122). In certain embodiments, the chamber lid (108) and/or locking assembly (110) may be spring loaded or include a biasing device which allows the chamber lid (108) to open when the micro-actuator transforms from an expanded condition to a non-expanded condition. Transformation of the micro-actuator from an expanded condition to a non-expanded condition may occur through the following process. First, with the micro-actuator being in an expanded condition, an electric current may be passed through electrical coils (170) positioned at various locations along a piezo material (172). As electricity is passed through the coils (170), an electric-magnetic field (EMF) is created which causes the piezo material (172) to stretch in a lateral direction. This causes an increase in distance between the first end (162) and the second end (164) of the micro-actuator (160) and results in the micro-actuator taking on a non-expanded configuration as the distance between the first lateral side (166) and the second lateral side (168) decreases. In order to return the micro-actuator (160) to the expanded state, electric current is discontinued from passing through the electrical coils (170) and the piezo material (172). This allows the piezo material (172) to laterally contract causing the distance between the first end (162) and the second end (164) to decrease and the distance between the first lateral side (166) and the second lateral side (168) to increase. The micro-actuator (160) may also include various structural supports (172) to provide stability to the device. In certain embodiments, the micro-actuator (160) may also be used in conjunction with the locking assembly (110) which is used to lock the primary lid (102) of the drug container (100). In such cases, the micro-actuator (160) and locking assembly (110) may both be positioned within the pocket (124) which is itself positioned along the side portion of the base (120).

In further embodiments, operation of the micro-actuator (160) and the locking assembly (110) as utilized to operate the locking mechanism for the primary lid (102) and the chamber lid (108) may be described as follows. The pocket (124) and the chamber lid (108) may include a biasing device (e.g., a spring) which causes the primary lid (102) and the chamber lid (108) to open by a biasing force (e.g., a spring force). When pressed down with a force sufficient to overcome the force of the biasing device, the primary lid (102) and/or the chamber lid (108) will be locked in place by the micro-actuator (160). This is achieved by the micro-actuator (160) being in an expanded configuration as described above. By closing either the primary lid (102) and/or the chamber lid (108), the first lateral side (166) and the second lateral side (168) will flex and return to its expanded configuration to hold the primary lid (102) and/or chamber lid (108) in conjunction with the locking assembly (110) in a locked position. When the micro-actuator is electrically powered, the micro-actuator will transform into a non-expanded configuration, as described above, causing the locking assembly (110) to disengage and unlock the primary lid (102) and/or chamber lid (108). This will in turn cause the primary lid (102) and/or chamber lid (108) to open through the upwards force applied by the biasing device. This mechanism may be configured so that only specifically defined chambers can be opened and accessed by the patient, pharmacist or physician.

The touch screen interface may be located anywhere on the inside of the DC and/or anywhere on the outside of the DC and is used as the patient's user interface for the DC software package. In the embodiments illustrated within FIGS. 4a and 4b, the touch screen (104) is accessible from the outside of the DC through an opening within compartment lid (102). The touch screen (104) may be used to provide information about the drug. Such information may include but is not limited to the following—the name of the drug, details about the prescription, recommended service times, number of doses taken, amount of prescription remaining, time until next refill, any potential interactions with other drugs as well as specific warnings about consummation with alcohol, operating machines or driving cars or such.

The Connection Base (CB) is mainly used as the connection interface between the DC and the computer at the doctor's office, the pharmacy, as well as for the patient's home. The CB allows for all connection interfaces currently available on the market such as Bluetooth, Wi-Fi, as well as USB. The CB may also operate as the charging station for the DC. In certain embodiments, the CB may be carried by the patient to the doctor's office and pharmacy which the doctor and pharmacist may connect to a computing device. In other embodiments, the doctor's office and pharmacy may have a CB on-site which the patient can connect the DC to. In addition, the patient may also have a CB although it is not necessary for the patient to have a CB in such embodiments. The CB allows for using all the usual connection interfaces currently available on the market such as Bluetooth, Wi-Fi as well as USB. The CB may also be used as the charging station for the DC.

In another aspect of the present disclosure, the system may be specifically programmed and designed for use in hospitals, medical centers or other health care facilities. In such embodiments, the physician software package, pharmacist software package and device software package may incorporate all of the specific regulations of the health care facility and include features which address the day-to-day challenges of such facilities. Although the basics of the system would be the same, the software packages would be different to adhere to those specifics.

Analytics Software Package (ASP)

Also provided with the PSS is an analytics software package (ASP). The analytics software package is used to analyze not only the patient and prescription drug related data but also to analyze the complete prescription drug chain throughout the prescription, filling and consumption process. The ASP provides healthcare providers (and any other authorized personnel) all of the information necessary to analyze the behavior of the patient in relation to adherence to the prescription. This can be especially helpful in cases where failure to adhere to the prescription can lead to an increase in the severity of the illness and/or an increased risk for ER visits or fatalities.

The basis for the ASP is a Central Prescription Database (CPD) where all the information, collected during the prescription process and usage by the patient is decrypted, verified, input into and sorted in a searchable database. Each dataset may then be encrypted and saved. The database may be structured in such way that authorized access is only granted to a specific set of data based on authorization levels of the authorized personnel.

With respect to data from the medical doctor package (MDP), the same encrypted file (4096 bit) which is created at the end of the prescription procedure and sent to the pharmacist, or stored at a memory device and handed to the patient will be sent to the health care provider. This file would contain the complete set of data about the patient and the prescription drugs. In case where there is a history of electronic data about the patient available at that doctor's office, that data may be encrypted in the same way as the prescription itself and added to the transmission file.

With respect to data from the pharmacy software package (PHP), at the end of the filling procedure of the DC, the pharmacist confirms the fulfillment of the prescription by marking off a list of questions to be answered including confirming any authorized substitution of the prescribed drugs with generics. The analytic part of the PHP creates an encrypted data file and automatically transmits that file to the CPD. It is then automatically decrypted, and all information are applied to the specific fields of the database, while comparing critical information about the prescription fulfillment to the prescribed drug(s).

With respect to data from the Patient Software Package (PTP), the DC device hardware includes all necessary radio technology to connect to Wi-Fi, Bluetooth, cell-phone or USB to common communication interfaces. The software package includes the ability to collect any data relevant for analysis of the patient's behavior in relation to the attempted effect of the prescription drug(s). This includes, but is not limited to: adherence to frequency, dosage and time of drug consumption, usage of provided drug information, registration of frequency and amount of discrepancy to prescribed regiment. This data will be encrypted at all times and whenever connection to the database is available for the data to be automatically transmitted. Transmission of the data may be accomplished through a push or pull transmission as is determined to be suitable for particular embodiment. The analysis will undergo the same protocol as described above with respect to the MDP and PHP.

Data Created Emergency Alerts

In cases where an aberration from the prescription regiment can create a life threatening situation, any critical deviation from a scheduled consumption or service will trigger an alert. The first alert may be immediate to the patient and utilize interfaces which connect to a patient's Smart Phone, Smart TV or other wearable or non-wearable electronic device. Such wearable electronic devices may also be a part of the ID process during the prescription filling procedure. In other circumstances, alerts can be transmitted to monitoring entities or organizations which then contact the patient directly or an appropriate health care provider. In certain embodiments the system may also include a specifically designed wristband that is not only used as part of the authorization procedure, but also allows the measurement and transfer of several vital signs, including but not limited to blood pressure, heart beat frequency, skin impedance and any other vital sign which may be deemed suitable for monitoring. The analysis and comparison of vital signs to known reactions of the human body and especially the reaction of the specific patient to the consumption of the prescription during the period of drug adjustment will allow for a better analysis and understanding of the reasons for adherence and/or non-adherence to prescribed regiments. It will also allow health care professionals to initiate an immediate reaction for urgent treatment in case of critical situations where patients have severe or life threatening illnesses.

Monitoring and Analytics at Database (CPD)

The CPD may contain a number of different data fields separated in a way that allows one to regulate and control access to such fields by different authorization levels. Every data field may be encrypted. Patient personal data is separately secured and only accessible with specific authorization.

Since any prescription process by the PSS triggers an input into the CPD, the CPD will over time, become the basis for the patient's prescription and/or medical history. It will also become a main source of information used by health care providers to conduct an analysis of prescription drug usage, prescription adherence and to generate a list of alerts for potential adverse reactions to specific prescriptions and/or prescription combinations.

Clause 1—A prescription security system including an electronically controlled drug container which includes a memory, a microprocessor, a software package, a power source, an input port, an output port, wherein the drug container receives and transmits data related to a patient through the input and output port; a physician software package which includes a protocol for writing a prescription for the patient and allows prescription data to be entered into the drug container upon completion of the protocol, wherein the drug container software package communicates with the physician software package to load prescription data into the memory of the drug container; and a pharmacy software package which provides a protocol verifying and authenticating the prescription data stored on the drug container and a protocol for verifying the identity of the patient, wherein the drug container software package acts as an interface between the drug container and the pharmacy software package.

Clause 2—The prescription security system of clause 1, wherein the physician software package includes at least one security element to ensure that the correct prescription is prescribed to the patient.

Clause 3—The prescription security system of clause 1 or 2, wherein the security element within the physician software package requires a check of the patient's identity.

Clause 4—The prescription security system of clauses 1-3, wherein the security element of the physician software package requires that the drug container be placed on a connection base.

Clause 5—The prescription security system of clauses 1-4, wherein the security system of the physician software package blocks the physician software package from issuing a prescription in the event that the identity of the patient is not confirmed or the drug container is not placed on the connection base.

Clause 6—The prescription security system of clauses 1-5, wherein after a physician enters a specific proposed drug into the physician software package, the physician software package performs a drug check to compare the patient's prescription history with all of the other, already prescribed drugs for interactions with the proposed drug.

Clause 7—The prescription security system of clauses 1-6, wherein the physician software package generates a list of any potential interactions between the proposed drug and the already prescribed drugs on a screen for the physician, wherein the list is coded based on the severity of the interactions and wherein a warning is generated if a potential dangerous interaction between drugs is discovered.

Clause 8—The prescription security system of clauses 1-7, wherein after the drug check is completed, the physician enters dosage information within the physician software package and wherein the physician software package checks the dosage information against any regulations and catalogues containing the patient's personal data.

Clause 9—The prescription security system of clauses 1-8, wherein the prescription is loaded into the drug container from the physician software package and wherein the prescription is encrypted on only accessible with use of an identification number and an acceptable software package.

Clause 10—The prescription security system of clauses 1-9, wherein the pharmacy software package includes a connection base which connects the drug container to a computer and wherein the pharmacy software package loads data from the drug container and checks the authenticity of a prescription against the patient, the patient's physician and a prescribed drug database.

Clause 11—The prescription security system of clauses 1-10, wherein at least one identifier is entered into the pharmacy software package in order to fill the prescription and wherein the pharmacy software package performs a verification check upon entering the at least one identifier.

Clause 12—The prescription security system of clauses 1-11, wherein a pharmacist fills chambers within the drug container with drugs as prescribed, according to dosage, interval and number of doses based on the prescription and software arrangements operating the drug container.

Clause 13—The prescription security system of clauses 1-12, wherein the pharmacy software package locks the drug container according to the prescribed usage.

Clause 14—The prescription security system of clause 1-13, wherein the drug container software package loads a prescription into the memory, secures data within the memory, allows data to be available to the pharmacist and controls usage of a prescribed drug as intended by a physician.

Clause 15—The prescription security system of clause 1-14, wherein the drug container software package unlocks a lid on the drug container upon confirmation of the prescription by the pharmacist.

Clause 16—The prescription security system of clauses 1-15, wherein the drug container software package determines the number of chambers needed per day and arranges the chambers of the drug container according to number of doses per day.

Clause 17—The prescription security system of clauses 1-16, wherein the drug container includes a screen on an inside portion of the lid and wherein the drug container software package loads a graphic of the chamber on the screen and shows the drug name and number of pills for each chamber on the screen.

Clause 18—The prescription security system of clauses 1-17, wherein the graphic is also shown on the pharmacist's computer screen, wherein the pharmacist can mark a chamber as filled on the computer screen upon filling the chamber with the prescription and wherein the drug container is electronically locked upon filling the prescription within the drug container.

Clause 19—The prescription security system of clauses 1-18, wherein the patient may open the drug container with an additional device or a biometric identification system, wherein the additional device is capable of electronically or remotely sending a signal.

Clause 20—The prescription security system of clauses 1-19, wherein the drug container may be connected to a separate programmable device which sends alert information about an upcoming dose, an alarm when time has expired for a service and other information about the drug to the drug container.

Notwithstanding that the numerical ranges and parameters setting forth the broad scope of the present teachings are approximations, the numerical values set forth in the specific examples are reported as precisely as possible. Any numerical value, however, inherently contain certain errors necessarily resulting from the standard deviation found in their respective testing measurements.

While the electronic system has been described above in connection with various illustrative embodiments, it is to be understood that other similar embodiments may be used or modifications and additions may be made to the described embodiments for performing the same function disclosed herein without deviating therefrom. Further, all embodiments disclosed are not necessarily in the alternative, as various embodiments may be combined or subtracted to provide the desired characteristics. Variations can be made by one having ordinary skill in the art without departing from the spirit and scope hereof. It is intended by applicant to include all such modifications and alterations insofar as they come within the scope of the appended claims or the equivalents thereof. Therefore, the electronic system should not be limited to any single embodiment, but rather construed in breadth and scope in accordance with the recitations of the appended claims.

Having thus described the present teachings, it is now claimed:

1) A prescription security system comprising:
an electronically controlled drug container which includes a memory, a microprocessor, a software package, a power source, an input port, an output port, wherein the drug container receives and transmits data related to a patient through the input and output port;
a physician software package which includes a protocol for writing a prescription for the patient and allows prescription data to be entered into the drug container upon completion of the protocol, wherein the drug container software package communicates with the physician software package to load prescription data into the memory of the drug container; and
a pharmacy software package which provides a protocol verifying and authenticating the prescription data stored on the drug container and a protocol for verifying the identity of the patient, wherein the drug container software package acts as an interface between the drug container and the pharmacy software package.

2) The prescription security system of claim 1, wherein the physician software package includes at least one security element to ensure that the correct prescription is prescribed to the patient.

3) The prescription security system of claim 2, wherein the security element within the physician software package requires a check of the patient's identity.

4) The prescription security system of claim 3, wherein the security element of the physician software package requires that the drug container be placed on a connection base.

5) The prescription security system of claim 4, wherein the security system of the physician software package blocks the physician software package from issuing a prescription in the event that the identity of the patient is not confirmed or the drug container is not placed on the connection base.

6) The prescription security system of claim 5, wherein after a physician enters a specific proposed drug into the physician software package, the physician software package performs a drug check to compare the patient's prescription history with all of the other, already prescribed drugs for interactions with the proposed drug.

7) The prescription security system of claim 6, wherein the physician software package generates a list of any potential interactions between the proposed drug and the already prescribed drugs on a screen for the physician, wherein the list is coded based on the severity of the interactions and wherein a warning is generated if a potential dangerous interaction between drugs is discovered.

8) The prescription security system of claim 7, wherein after the drug check is completed, the physician enters dosage information within the physician software package and wherein the physician software package checks the dosage information against any regulations and catalogues containing the patient's personal data.

9) The prescription security system of claim 8, wherein the prescription is loaded into the drug container from the physician software package and wherein the prescription is encrypted on only accessible with use of an identification number and an acceptable software package.

10) The prescription security system of claim 1, wherein the pharmacy software package includes a connection base which connects the drug container to a computer and wherein the pharmacy software package loads data from the drug container and checks the authenticity of a prescription against the patient, the patient's physician and a prescribed drug database.

11) The prescription security system of claim 10, wherein at least one identifier is entered into the pharmacy software package in order to fill the prescription and wherein the pharmacy software package performs a verification check upon entering the at least one identifier.

12) The prescription security system of claim 11, wherein a pharmacist fills chambers within the drug container with drugs as prescribed, according to dosage, interval and number of doses based on the prescription and software arrangements operating the drug container.

13) The prescription security system of claim 12, wherein the pharmacy software package locks the drug container according to the prescribed usage.

14) The prescription security system of claim 1, wherein the drug container software package loads a prescription into the memory, secures data within the memory, allows data to be available to the pharmacist and controls usage of a prescribed drug as intended by a physician.

15) The prescription security system of claim 14, wherein the drug container software package unlocks a lid on the drug container upon confirmation of the prescription by the pharmacist.

16) The prescription security system of claim 15, wherein the drug container software package determines the number of chambers needed per day and arranges the chambers of the drug container according to number of doses per day.

17) The prescription security system of claim 16, wherein the drug container includes a screen on an inside portion of the lid and wherein the drug container software package loads a graphic of the chamber on the screen and shows the drug name and number of pills for each chamber on the screen.

18) The prescription security system of claim 17, wherein the graphic is also shown on the pharmacist's computer screen, wherein the pharmacist can mark a chamber as filled on the computer screen upon filling the chamber with the prescription and wherein the drug container is electronically locked upon filling the prescription within the drug container.

19) The prescription security system of claim 18, wherein the patient may open the drug container with an additional device or a biometric identification system, wherein the additional device is capable of electronically or remotely sending a signal.

20) The prescription security system of claim 19, wherein the drug container may be connected to a separate programmable device which sends alert information about an upcoming dose, an alarm when time has expired for a service and other information about the drug to the drug container.
